(19) United States
(12) Patent Application Publication
(10) Pub. No.: US 2006/0175352 A1
(43) Pub. Date: Aug. 10, 2006

(54) Cleaning processes for a fluid dispensing system

(76) Inventors: Jorg Emmendorfer, Wuppertal (DE); Knut Richter, Freising (DE)

Correspondence Address: MERCHANT & GOULD PC, P.O. BOX 2903, MINNEAPOLIS, MN, 55402-0903, US

(21) Appl. No.: 11/264,615

(22) Filed: Oct. 31, 2005

Related U.S. Application Data
(63) Continuation-in-part of application No. 10/985,302, filed on Nov. 9, 2004.

(51) Int. Cl. B67D 1/08

(52) U.S. Cl. 222/148; 222/1

(57) ABSTRACT

A beverage dispensing system having control-based functionality for managing a cleaning process for a beverage dispensing system is disclosed. The beverage dispensing system has one or more beverage containers that supply beverage(s) to beverage line(s), which in turn, supply the beverage(s) to dispense unit(s), or tap(s). The beverage lines include in-line pumps that facilitate the communication of beverages from the containers to the taps. The controller manages cleaning of the beverage dispensing system by selectively enabling and disabling operation of the pumps such that, during cleaning, the pumps are not operable for operation. Also disclosed is the application of an icy or slushy product to the beverage lines for optimal cleaning.

### RELATED APPLICATIONS

This application is a continuation-in-part of U.S. patent application Ser. No. 10/985,302, filed on Nov. 9, 2004 and entitled “CHEMICAL DISPENSE SYSTEM FOR CLEANING COMPONENTS OF A FLUID DISPENSING SYSTEM,” which is hereby incorporated by reference in its entirety.

Furthermore, this application is related to subject matter disclosed in U.S. patent application for CONTROLLER-BASED MANAGEMENT OF A FLUID DISPENSING SYSTEM, Ser. No. (Attorney Docket No. 00163.2104-US-01), U.S. patent application for MONITORING OPERATION OF A FLUID DISPENSING SYSTEM, Ser. No. (Attorney Docket No. 00163.2001-US-I2) and U.S. patent application for CONTROLLER-BASED MANAGEMENT OF A FLUID DISPENSING SYSTEM, Ser. No. (Attorney Docket No. 00163.2001-US-I4), each of which are filed on even date herewith and hereby incorporated by reference by their entirety.

### TECHNICAL FIELD

The present invention generally relates to fluid dispensing systems, and more particularly, to cleaning fluid dispensing systems.

### BACKGROUND

Conventional beer dispensing systems include beer lines through which beer is supplied from kegs to taps, which are operable to dispense the beer to drinking containers such as steins, pilsner glasses and frosty mugs. When a tap is opened, beer is dispensed from the system as a pressure is exerted into the associated keg thereby forcing beer out of the keg and into a beer line fluidly coupled to the keg by way of a keg coupler. The pressure is typically supplied by a gas source such as, for example, a tank of carbon dioxide or nitrogen or a gas blender providing a mixture of gases. Regardless of the type of gas source employed, the keg coupler interfaces the applied pressure to the keg, which is thus pressurized such that any beer contained therein is pushed up to the beer lines through the coupler. The associated tap at the other end of the beer line from the keg may then be opened thereby allowing beer to be dispensed therefrom.

Monitoring operation of such conventional beer dispensing systems is purely a manual process. As such, bartenders and restaurant managers typically spend countless hours each month performing various maintenance and operating tasks such as, for example, switching between kegs, monitoring beer usage and estimating future demand figures. In addition to standard operating tasks, beer dispensing systems require periodic cleaning. Conventional cleaning approaches involve the use of portable chemical dispense systems. In this regard, a cleaning technician will manually disconnect the beer lines from each individual keg coupler and then apply cleaning chemicals to the beer lines with the taps in the open position such that the chemicals will be distributed through the lines. Thus, a technician is required to disconnect the beer line from each keg in a beer dispensing system being cleaned, which is a daunting task indeed. Because current approaches require so much time and effort on part of the cleaning technicians, beer dispensing systems are commonly cleaned on rather lengthy time intervals. Such lengthy cleaning intervals tend to facilitate the collection of bacteria and soil in the beverage lines thereby risking contamination with the beer and potentially making it somewhat unsafe for human consumption.

Further contributing to an already inefficient process are changes to the structural configuration of conventional beer dispensing systems. For example, beer pumps may be used in beer lines to facilitate the communication of beer to the taps. Beer pumps are typically used in installations in which the kegs are located a considerable distance from the taps. While providing certain benefits, these devices provide further obstacles for cleaning particularly due to the fact that, during cleaning, functionality of each pump in the lines being cleaned must be manually overridden (e.g., when taps are maintained as opened during cleaning). If not manually shut off, the pumps would expose the system to a vacuum. Accordingly, the more beer pumps, the more time a service technician must spend cleaning the system.

While only beer dispensing systems are described above, these drawbacks are commonly known to exist with respect to other types of fluid dispensing systems. As such, it is against this background that the present invention has been made relative to all types of fluid dispensing systems.

### SUMMARY OF THE INVENTION

The present invention is generally directed to a computer-implemented approach to managing cleaning processes of a fluid dispensing system. To accomplish this, the fluid dispensing system includes a controller operable to receive and track information regarding operation of the system relative to both processes. The fluid dispensing system also includes at least one fluid container fluidly coupled to a fluid line, which is fluidly coupled to a dispense unit. In response to opening the dispense unit, fluid is communicated from the fluid container to the dispense unit via the fluid line.

In an embodiment, the fluid line includes an in-line pump that facilitates the communication of fluid from the container to the dispense unit. Management of a fluid dispensing system according to this embodiment is practiced by a method that is performed at least in part by the controller. In response to a request to clean the fluid line, this method involves disabling the in-line pump such that the pump is not operable to assist with pushing fluid to dispense unit, when opened. After the in-line pump has been disabled, the method involves initiating the cleaning process by instructing supply of a substance to the fluid line for communication to the dispense unit.

The present invention may also be embodied in the form of a system having, in addition to the controller, at least one fluid container, at least one fluid line, at least one dispense unit, at least one fluid pump and at least one power source. The fluid line is fluidly connected to the fluid container by way of a coupler. The dispense unit is fluidly connected to the fluid line includes comprising a valve that, when open, allows fluid to flow from the fluid container through the coupler to the fluid line and out of the dispense unit. The fluid pump is integrated into the fluid line and helps push fluid to the dispense unit when the valve is open. The power source provides power to the fluid pump and is communicatively coupled to the controller by way of a data communication link, which may be wired or wireless based medium. The controller selectively enables and disables the fluid pump by issuing control communications to the power source over the data communications link. Therefore, prior to cleaning the fluid line, the controller disables the fluid so that a substance may be provided to the fluid line for cleaning purposes.

In accordance with alternative embodiments, the fluid pump may be an electric pump or a pneumatic pump. Regardless of the type, however, the power source for the fluid pump is controlled by the controller in order to disable the pump such that cleaning processes may begin.

In accordance with yet another embodiment, the present invention involves the application of an icy or slushy product to the fluid lines during cleaning thereof. To accomplish this, a fluid is maintained at a temperature slightly above freezing temperature. An ultrasonic wave generator is positioned in relation to the fluid line and selectively activated to propagate ultrasonic waves in the direction of the fluid lines as the fluid is being communicated therethrough, thereby resulting in transforming the fluid to an icy or slushy form. It is contemplated that the fluid may be any fluid such as, for example, a beverage, water or a cleaning fluid. In accordance with a specific embodiment, the fluid container contains a beverage and the beverage, and more particularly, an icy form thereof, is the substance used to clean the lines.

These and various other features as well as advantages, which characterize the present invention, will be apparent from a reading of the following detailed description and a review of the associated drawings.

### BRIEF DESCRIPTION OF THE DRAWINGS

FIG. 1 is a fluid dispensing system having an integrated controller-based chemical dispense system for cleaning components of the fluid dispensing system and having an in-line pump in at least one fluid line in accordance with an embodiment of the present invention.

FIG. 2 depicts a gas-fluid junction and a coupler, and an exemplary connection therebetween for use in the fluid dispensing system shown in FIG. 1.

FIG. 3 illustrates in block diagram form a system for controlling operation of the in-line pump shown in FIG. 1 to facilitate cleaning of the fluid dispensing system in accordance with various embodiments of the present invention.

FIG. 4 is a flow diagram illustrating operational characteristics for controlling operation of the in-line pump shown in FIG. 1 to facilitate cleaning of the fluid dispensing system in accordance with an embodiment of the present invention.

FIG. 5 is a fluid dispensing system having a fluid line and a device for cleaning the fluid line in accordance with an alternative embodiment of the present invention.

FIG. 6 illustrates in block diagram form a system for controlling operation of the device shown in FIG. 1 to facilitate cleaning of the fluid dispensing system in accordance with various embodiments of the present invention.

FIG. 7 depicts a general-purpose computer that may be configured to implement logical operations of the present invention in accordance with an embodiment thereof.

### DETAILED DESCRIPTION

The present invention and its various embodiments are described in detail below with reference to the figures. When referring to the figures, like structures and elements shown throughout are indicated with like reference numerals. Objects depicted in the figures that are covered by another object, as well as the reference annotations thereto, are shown using dashed lines.

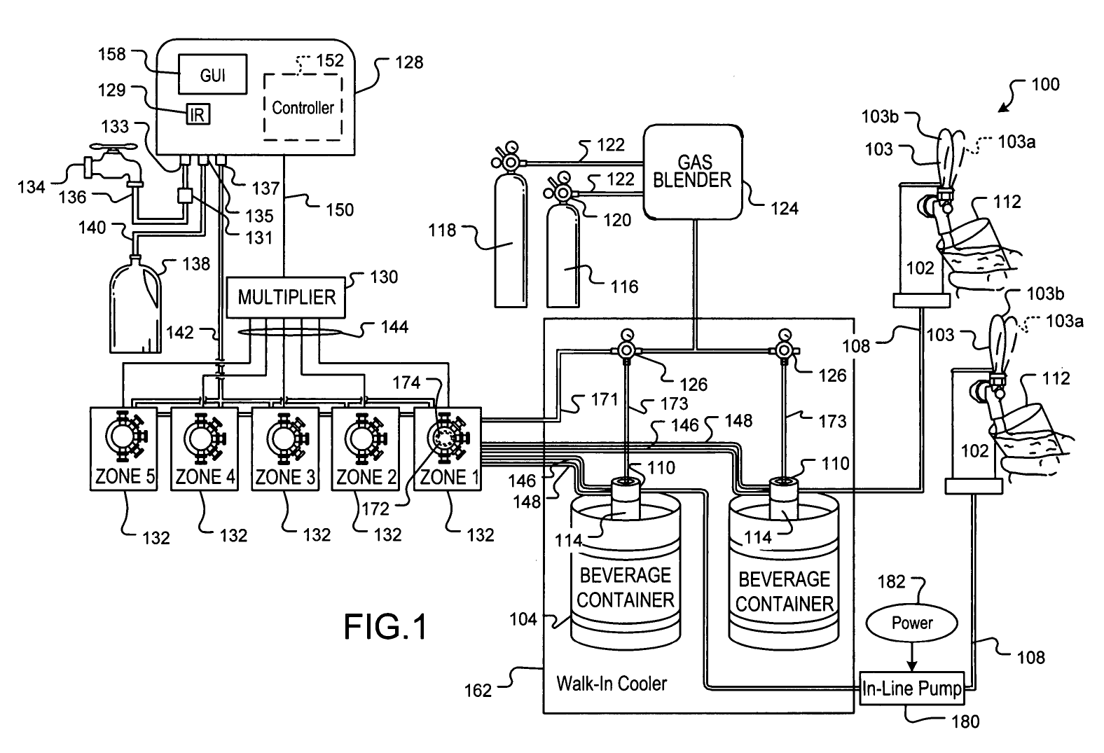

The present invention is generally directed to managing operation of a fluid dispensing system, and in accordance with a specific embodiment, a beverage dispensing system (e.g., 100 shown in FIG. 1). The beverage dispensing system 100 administers beverage-dispensing processes during which beverages are provided to dispense units 102, or “taps,” for dispensing to cups, mugs, glasses or steins for consumption by a user. Embodiments of the present invention relate to monitoring and controlling these dispensing processes in automated fashion as described in greater detail below with reference to the figures.

Also, in an embodiment, the present invention involves monitoring and controlling a chemical dispense system for use in cleaning the beverage dispensing system 100, as described in parent application Ser. No. 10/985,302 and U.S. patent application Ser. No. 11/142,995 (filed Jun. 1, 2005), which is also entitled “CHEMICAL DISPENSE SYSTEM FOR CLEANING COMPONENTS OF A FLUID DISPENSING SYSTEM” and, like parent application Ser. No. 10/985,302, is hereby incorporated by reference herein by its entirety. The chemical dispense system is integrated into the beverage dispensing system 100, and thus, referred to as an “in-line” cleaning system. In operation, the in-line cleaning system administers a “cleaning process” to the beverage dispensing system 100 in which the various fluid-carrying lines and components are cleaned in accordance with embodiments described in the above- referenced patent applications. With that said, the beverage dispensing system 100 is described generally below in accordance with embodiments of the present invention to include the in-line cleaning system and, thus, the present invention is applicable to monitor and control not only beverage dispensing processes, but cleaning processes as well. Those of skill in the art will therefore recognize applicability of the various embodiments of the present invention to both a stand-alone beverage dispensing system 100 and also a beverage dispensing system 100 having an in-line cleaning system.

While many different types of beverages and beverage dispensing systems are contemplated within the scope of the present invention, the beverage dispensing system 100 is described as being a beer dispensing system used to dispense beer to a bar area of a restaurant. Indeed, those of skill in the art will appreciate that the beverage dispensing system 100 is operable to dispense any other type of beverage, such as, for example, soda, juices, coffees and dairy products. Even further, the beverage dispensing system 100 may be utilized to dispense fluids other than beverages such as, for example, paint.

With the above-described environment in mind, FIG. 1 shows a beverage dispensing system 100 in accordance with an embodiment of the present invention. The beverage dispensing system 100 dispenses different labels of beer through individual dispense units 102, as shown in FIG. 1 in the form of conventional beer taps. The dispense units 102 include handles 103 that may be toggled between an “off” position 103b and an “on” position 103a, the latter of which is shown using dashed lines. While the handles 103 are in the “off” position 103b, the dispense units 102 preclude the flow of beer therefrom. Conversely, while the handles 103 are in the “on” position 103a, the dispense units 102 enable the flow of beer therefrom and preferably to some form of drinking article, such as a stein or mug 112. To illustrate embodiments of the present invention, the dispense units 102 are shown in FIG. 1 with the handles 103 in the “on” position 103a.

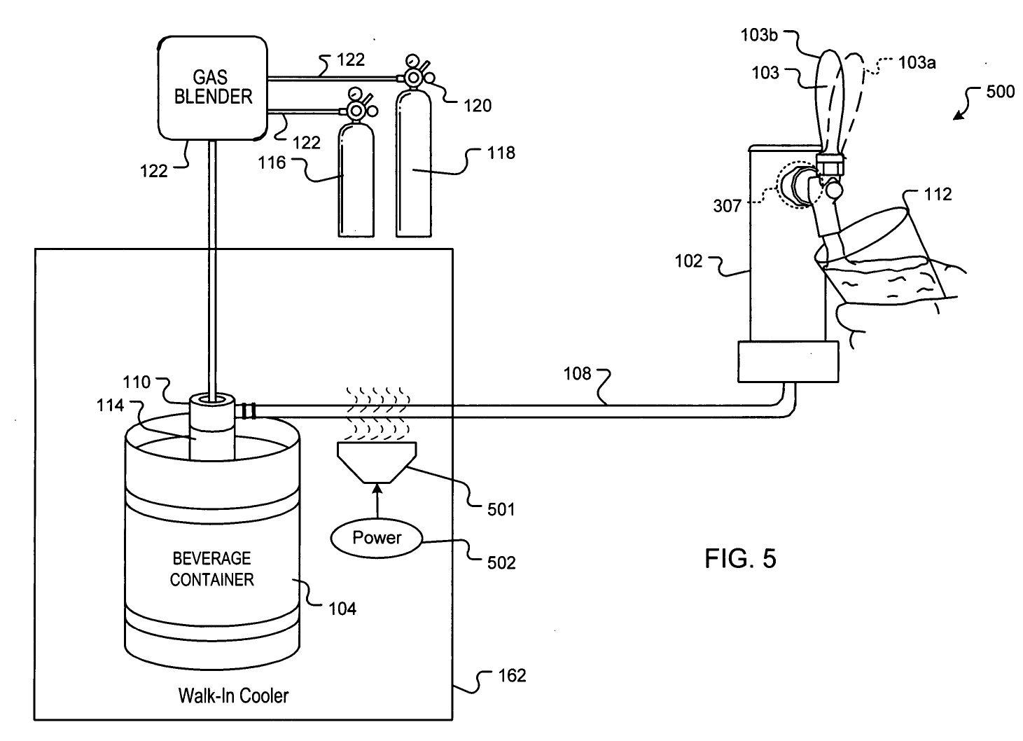

Prior to being dispensed, the beverages are contained in beverage containers 104. The beverage containers 104 are illustrated in FIG. 1 as being conventional-sized kegs in accordance with an embodiment of the present invention. However, any other type and size of container (e.g., tank valves) from which a beverage may be supplied will suffice, as shown in FIG. 5 and described in connection therewith. Whereas the dispense units 102 are preferably located in the bar area, the beverage containers 104 are stored in a cooling room, such as walk-in cooler 162, in order to direct and maintain the temperature of the beverages at a desired temperature.

Each dispense unit 102 is fluidly connected to a beverage container 104 by a beverage line 108. In accordance with an embodiment, an optional beverage pump 180 may be provided within any one of the beverage lines 108 to assist in providing the associated beverage to the associated dispense unit 102. Such an implementation is preferable when the distance between a beverage container 104 and an associated dispense unit 102 is a relatively great distance. As known to those skilled in the art, each beverage pump 180 is configured such that when the associated dispense unit 102 is positioned in the on position 103a, the beverage pump 180 is activated to facilitate the transport of beverage to the dispense unit 102. Conversely, when the handle 103 of the associated dispense unit 102 is positioned in the off position 103a, the beverage pump 180 is de-activated.

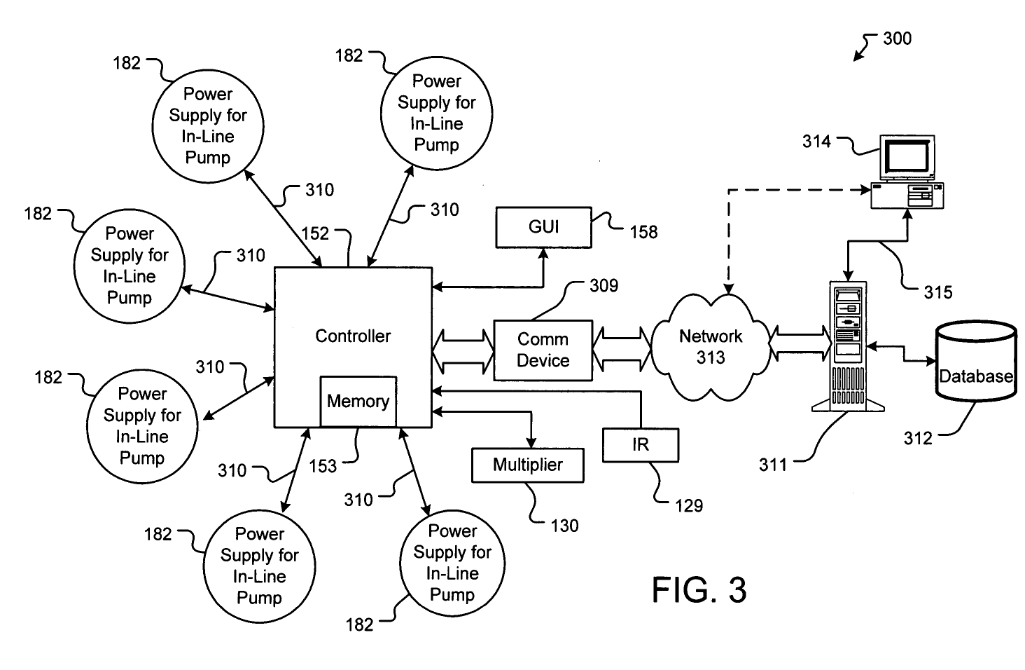

The beverage pump 180 is described in the above paragraph (with reference to handle 103 operation) to be an electric pump in accordance with an exemplary embodiment, but may alternatively be a pneumatic pump. As such, the beverage pump 180 is shown in FIG. 1 to be powered by a generalized power source 182. If the beverage pump 180 is an electric pump, then the power source 182 embodies a switch that, when enabled, provides the requisite electrical power to engage the beverage pump 180 for activation when the dispense unit 102 is positioned in the on position 103a. If the beverage pump 180 is a pneumatic pump, then the power source 182 embodies a valve that, when enabled, provides the requisite air or pressure to engage the beverage pump 180 for activation when the dispense unit 102 is positioned in the on position 103a. Regardless of type, however, the power source 182 is enabled by way of data communications from a controller over either wireless or wire-based communication media 310, as described in greater detail below in conjunction with FIG. 3.

Each beverage line 108 is connected to an associated beverage container 104 by a coupler 110. The couplers 110 are affixed to beverage ports 114 on the associated beverage containers 104 through which the beverages are output for direction by the couplers 110 to the associated beverage lines 108. Each coupler 110 provides functionality for opening the beverage port 114 to which the coupler 110 is affixed and introducing a pressure into the associated beverage container 104 to force the beverage contained therein through the beverage port 114 and to the associated beverage line 108. The connection provided by the coupler 110 between the beverage port 114 and the beverage line 108 is preferably air tight, and thereby operable to force the beverage through the associated beverage line 108 and to the associated dispense unit 102. Depending on the position of the dispense unit 102, dispensing of the beverage from the unit 102 is either precluded (i.e., handle 103 in “off” position 103b) or enabled (i.e., handle 103 in “on” position 103a).

The pressure used to force beverages from the beverage containers 104 to the dispense units 102 via the beverage lines 108 is supplied to the couplers 110 from one or more pressure sources, e.g., 116 and 118. These pressure sources 116, 118 are shown in accordance with an embodiment as being compressed gas tanks having different reference numerals (i.e., 116 and 118) to differentiate between the different types of gas contained by each. For example, pressure source 116 includes carbon dioxide and pressure source 118 includes nitrogen in accordance with an exemplary embodiment.

Each gas tank 116 and 118 includes a primary regulator 120. The primary regulators 120 regulate the flow of gas from the gas tanks 116, 118 to a gas blender 124 via gas lines 122. The gas blender 124 blends the gases from the gas tanks 116 and 118 and provides a mixed gas compound to secondary regulators 126. Each of the secondary regulators 126 regulate the flow of the mixed gas compound from the gas blender 124 to individual couplers 110, thereby providing the requisite pressure to force the beverages from the beverage containers 104 to the dispense units 102. As such, there exists a 1:1 correlation between secondary regulators 126 and beverage containers 104. In accordance with alternative embodiments, a single secondary regulator 126 may regulate the flow of the mixed gas compound to more than one beverage container 104.

As described above in accordance with an embodiment of the present invention, the beverage dispensing system 100 includes an in-line cleaning system that administers a cleaning process applied to the beverage dispensing system 100. The in-line cleaning system encompasses various components of the beverage dispensing system 100 such as, without limitation, the couplers 110, as well as a control system 128, a zone controller 130 (optional), various data communications lines (e.g., 150 and 144), various substance communication lines (e.g., 146 and 148) and gas-fluid junctions 132, each of which are shown generally in block diagram form in FIG. 1.

The control system 128 is a controller-based system that manages the overall administration of cleaning processes applied to the beverage dispensing system 100. In this regard, the beverage dispensing system 100 includes a controller 152 (internal to the control box 128) that controls and monitors various tasks administered by the control system 128 in performance of beverage dispensing and system cleaning processes. In accordance with an embodiment, the controller 152 is a PLC (programmable logic controller) providing hardened I/O (inputs/outputs) for the control system 128.

The control system 128 also includes one or more display devices or modules, such as, without limitation, a graphical user interface (GUI) 158. The GUI 158 allows a user to monitor and control operation of the control system 128 through a touch screen interface. For instance, the GUI 158 may present information to a user that represents the operational status of the beverage dispensing system 100 in performance of beverage dispensing processes or the in-line cleaning system in performance of cleaning processes. Such information may be in the form of icons selectable to control either process. For example, the GUI 158 may include icons selected by a user to initiate or suspend either the dispensing process or the cleaning process. Furthermore, the GUI 158 may present to the user a selection screen that enables the user to control aspects of the cleaning process by defining or modifying the phases of the cleaning process or the amount of time that each phase is to be administered. In addition, the GUI 158 may function as a security mechanism for limiting access to the control system 128 to authorized users.

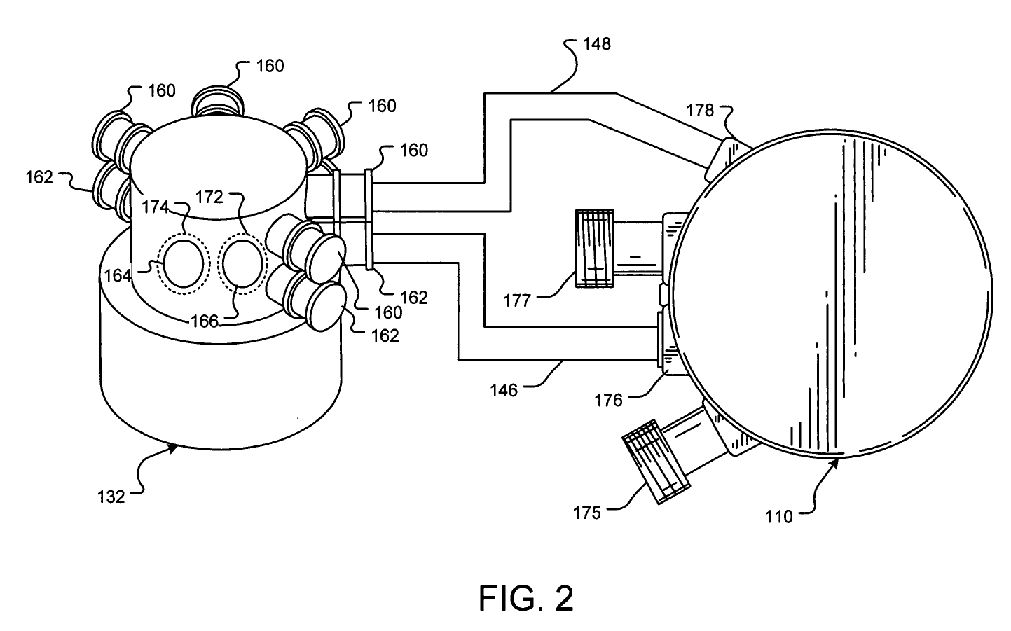

Alternatively, users may interact with the controller 152 by way of an external computer source, such as a handheld device, which may be wireless or wire-based. To effectuate the use wireless handheld devices, the control system 128 includes an infrared port 129 for communicating data to and from these devices. In yet another embodiment, the dispensing control system also includes a switching mechanism (not shown) for use in activating cleaning processes in desired zones, as described in greater detail with reference to FIGS. 2 and 8 of U.S. patent application Ser. Nos. 10/985,302 and 11/142,995, which, again, are incorporated by reference above.

The zone controller 130, which is also referred to as a “multiplier,” is a stand-alone component of the in-line cleaning system that works in combination with the GUI 158 or other data input means (e.g., external computer or switching mechanism) to activate the cleaning process in certain zones. As such, the zone controller 130 accepts user input from a source requesting the administration of one or more phases of the cleaning process to a zone and activates the phase(s) in that zone. The zone controller 130 is either an integrated circuit (IC) operable to receive and transmit signals for purposes of selecting the gas-fluid junctions 132 for activation, as described below, or a controller (e.g., PLC) programmed to receive and transmit data for these same purposes. In an alternative embodiment, the zone controller 130 may be a module integrated with the controller 152, and thus, contained within the housing of the control system 128.

The control system 128 is powered by a power source (not shown), which may be any conventional power source known to those skilled in the art. The control system 128 includes a first fluid input port 133 and a second fluid input port 135 through which water and chemical solutions, respectively, are input to the system 128. Water provided to the first fluid input port 133 is supplied by a potable water source 134 via a water input line 136. In an embodiment, a backflow prevention device 131 is positioned in the water input line 136 in order to preclude chemical solutions and contaminated water used during cleaning processes from backflowing into the potable water source 134.

Chemical solutions provided to the second fluid input port 134 are supplied from a solution container, such as a jug 138, via a solution input line 140. The control system 128 also includes a fluid output port 137 through which the water and chemical solutions are dispensed out of the system 128 by way of a fluid manifold 142. Those skilled in the art will appreciate that the control system 128 includes pumps, regulators or the like for enabling the flow of water and chemical solution into the system 128 via the water input line 136 and the solution input line 140 and subsequently out of the system 128 via the fluid manifold 142.

Water and one or more chemical solutions are provided by the control system 128 to the gas-fluid junctions 132 by way of the fluid manifold 142. The gas-fluid junctions 132, when activated by the zone controller as described below, distribute water and chemical solutions from the fluid manifold 142 to couplers 110 for distribution through the beverage lines 108, the dispense units 102 and any other component through which beverages flow. For illustration purposes, the gas-fluid junction 132 of zone 1 is shown as being connected to the beverage containers 104 by fluid lines 146 that carry the water and chemical solutions from this gas-fluid junction 132 to the couplers 110 when the gas-fluid junction 132 is activated.

The in-line cleaning system also includes gas lines 148 that carry a “control” gas from the gas-fluid junctions 132 to the associated couplers 110. Supply of the control gas to a coupler 110 dictates whether the beverage port 114 on the associated beverage container 104 is “open” or “closed,” and thus whether pressure from the gas blender 124 is allowed to enter the container 104. Consequently, the control gas dictates whether that beverage is operable to flow from the associated container 104 to the one or more corresponding dispense units 102 depending on the position (i.e., 103a or 103b) of the dispense unit(s) 103. To accomplish this, each of the couplers 110 includes a piston (not shown) that is responsive to the control gas to open the associated beverage port 114. The pressure from the gas blender 124 is constant and, as such, is substantially immediately introduced into the beverage container 104 in response to the piston opening the beverage port 114 under direction of the control gas. Conversely, termination of the supply of control gas to the couplers 110 results in the couplers 110 closing the associated beverage ports 114.

The operational state of the beverage dispensing system 100 involves the application of control gas to the couplers 110 and, during such application, beverages are operable to flow from the associated beverage containers 104 to the associated beverage lines 108 (depending, of course, on the positioning of the handles 103). Before any chemicals or water are supplied to a zone in the beverage dispensing system 100 for cleaning, supply of control gas to the couplers 110 in that zone is terminated and maintained terminated for the duration of the cleaning process. In effect, the non-application of control gas to these couplers 110 is intended to disable the flow of beverage from the associated beverage containers 104 to the associated beverage lines 108, at which time, the cleaning process may commence.

With reference now to FIG. 2, the gas-fluid junctions 132 and the couplers 110 are described in further detail. Each of the couplers 110 includes a beverage output port 177 from which beverages are supplied to an associated beverage line 108 during the beverage dispensing process. The beverage output ports 177 are fluidly coupled to the beverage lines 108 such that pressure supplied by the gas blender 124 is operable to force beverages from the beverage containers 104 to the beverage lines 108 with minimal loss.

Each of the gas-fluid junctions 132 includes a fluid input port 164 and a gas input port 166. The fluid input port 164 is fluidly coupled to the fluid manifold 142 and thus accepts fluids (e.g., water and chemical solution) therefrom. In an embodiment, the gas input port 166 is coupled to the gas blender 124 by way of a control gas line 171, which is provided to each of the gas-fluid junctions 132 as generally depicted in FIG. 1. Alternatively, the gas input port 166 may be coupled directly to either gas tank 116 or 118 without going through the gas blender 124. The gas-fluid junctions 132 also include a plurality of gas output ports 160 and a plurality of fluid output ports 162. Each of the plurality of gas output ports 160 are paired with one of the plurality of fluid output ports 162.

A control gas valve 172, generally represented using dashed lines, is situated internal to each gas-fluid junction 132 and provides functionality for the gas-fluid junctions 132 to accept and reject gas from the gas blender 124. In this regard, the control gas valve 172 fluidly connects the gas input port 166 to the plurality of gas output ports 160 such that gas from the blender 124 is operable to flow therebetween. Each of the gas output ports 160 is coupled to a gas input port 178 on a coupler 110 via a gas line 148 such that gas may flow therebetween. The communication of gas between the output ports 160 on a gas-fluid junction 132 and the gas input ports 178 on the couplers 110 served by that gas-fluid junction 132 operates to maintain the “open” state of the beverage ports 114 on the associated beverage containers 104, as described above. Conversely, terminating supply of gas between the output ports 160 and the gas input ports 178 operates to close the beverage ports 114 on the containers 104, also as described above. By effectively providing such control, this gas is appropriately referred to throughout this description as “control gas.”

A fluid control valve 174, also generally represented using dashed lines, is situated internal to each gas-fluid junction 132 and provides functionality for the gas-fluid junctions 132 to accept and reject water and chemical solutions from the control system 128. Thus, with similar reference to the control gas valve 172, the fluid control valve 174 fluidly connects the fluid input port 164 to the plurality of fluid output ports 162 such that water and chemical solutions are operable to flow therebetween. Each fluid output port 162 is coupled to a fluid input port 176 on a coupler 110 via a fluid line 146 such that the water and chemical solutions may flow therebetween.

The control gas valve 172 and the fluid control valve 174 are controlled by the zone controller 130 via a low voltage line 144 input to the gas-fluid junction 132 from the zone controller 130. In normal state, i.e., when the beverage dispensing system 100 is in beverage dispensing mode, the zone controller 130 does not issue a current to any of the gas-fluid junctions 132. In response to direction from the control system 128 to apply the cleaning process to a specific zone, the zone controller 130 issues a current to the gas-fluid junction 132 served by the specified zone thereby “activating” that gas-fluid junction 132. Such activation causes the control gas valve 172 of that gas-fluid junction 132 to close, thereby rejecting gas from the gas blender 124. Consequently, the supply of control gas to the couplers 110 served by the activated gas-fluid junction 132 (i.e., the couplers 110 within the associated zone) is terminated thereby causing the pistons internal to the couplers 110 to disengage the beverage ports 114 on the associated beverage containers 104. Substantially concurrently, the issued current opens the fluid control valve 174 to enable the communication of water and chemical solutions to the associated couplers 110. However, these fluids are not provided to the activated gas-fluid junction 132 unless and until the controller 128 initiates a cleaning process within that zone.

In an embodiment, each of the couplers 110 include a pressure input port 175 through which the gas pressure supplied from the gas blender 124 is introduced to the couplers 110. As noted above, gas is provided to the pressure input ports 175 in constant fashion and used to force beverages from the beverage containers 104 to the beverage lines 108 when the pistons internal to the couplers 110 are engaged (i.e., when the control gas is “on”). In an alternative embodiment, application of the control gas by itself may provide a sufficient amount of pressure to force beverages from the containers 104 to the beverage lines 108 without the added need for pressure from the gas blender 124. In accordance with this embodiment, the gas line 171 directly connects between the gas blender 124 and the pressure input port 175 as well as the secondary regulators 126 and the connections between these regulators 126 and the couplers 110 are not necessary. The implementation is a manner of choice and, regardless of how such control is administered, termination of the control gas to a specific zone results in the same functionality, i.e., sealing the associated beverage ports 114, such that the couplers 110 in that zone exit the beverage dispensing mode and enter the cleaning mode (thus awaiting possible initiation of a cleaning process).

With the general environment in which embodiments of the present invention are applicable provided above, FIG. 3 depicts, in block diagram form, a system for controlling operation of one or more beverage pumps 180 to facilitate application of the cleaning process to the associated beverage line(s) 108 in accordance with various embodiments of the present invention. In this embodiment, the beverage pumps 180 each include a power source 182, as illustratively shown in FIG. 1. The power sources 182 are communicatively connected to the controller 152 by way of data communication connections 310.

In an embodiment, the data communication connections 310 are wire-based communication media operable to carry a current indicative of instructions from the controller 152 to the power sources 182. These data communication connections 310 may additionally or alternatively embody wireless communication technology. It should be appreciated that the manner of implementation of the data communication connections 310 is a matter of choice and the present invention is not limited to one or the other, but rather, either wireless or wire-based technology may be employed alone or in combination with the other. Regardless of the implementation, the power sources 182 act in response to instructions transmitted by the controller 152 and either engage or disengage accordingly. If a beverage pump 180 is an electric pump, the associated power source 182 engages by electrically switching power to the pump 180 and, similarly, disengages by switching the power to the pump 180 off. If a beverage pump 180 is a pneumatic pump, the associated power source 182 engages by providing air or pressure to the pump 180, and similarly, disengages by shutting off the air or pressure to the pump 180.

The controller 152 receives information regarding operation of the beverage dispensing system 100 and stores this information to memory 153. The memory 153 is shown as internal to the controller 152 and embodies any form of solid state, non-volatile memory known to those skilled in the art such as, for example, Random Access Memory (RAM), Read-Only Memory (ROM), Erasable Programmable ROM (EPROM), Electrically-Erasable Programmable ROM (EEPROM), Flash Memory and Programmable ROM, etc. Alternatively, the memory 153 may take the form of storage medium readable by an external peripheral device such as, for example, a hard disk, a CD-ROM, a DVD, a storage tape, etc.

The monitoring system 300 is shown to include parts of the dispensing control system 128 in addition to the controller 152 in accordance with an embodiment of the present invention. Specifically, the monitoring system 300 also includes the zone controller 130 (again, optional), the GUI 158 and the IR port 129. The GUI 158 and the IR port 129 provide users with access to data captured by the sensors 302 as well as any analyses performed by the controller 158 thereon. As such, user interaction is provided by touch screen interface (on GUI 158) or by way of a mobile computer such as a laptop, PDA or other handheld computing device (via IR port 129). Using the GUI 158 and/or a mobile computer interacting through the IR port (129), a user is provided with functionality for monitoring operation of the beverage dispensing system 100 as well as to view reports prepared using the sensed information.

In addition to the local user interaction provided by the GUI 158 and the IR port 129, the monitoring system 300 also provides users with the capability to monitor operation of the beverage dispensing system 100 from remote locations. To accomplish this, the monitoring system 300 includes a remote, or “server,” computer 310 communicatively connected to the controller 152 by way of a communications network 313. The server computer 311 communicates with the controller 152 to retrieve data stored on the memory 153, which may include any information sensed from the flow sensors 302 and any other sensors and/or information embodying analyses (e.g., reports) of such data performed by the controller 152 including, for example, data related to control over both the beverage dispensing process and the cleaning process. Once retrieved, the information is stored on a database 312 for future access by users. In this regard, the server computer 311 functions as a user interaction mechanism much like the GUI 158 and the IR port 129, but from a remote location relative to the actual location of the system 100.

The controller 152 connects to the communications network 313 by way of a communication device 309. The communication device 309 may be a modem, a network interface card (NIC) alone or in combination with a router, hub or Ethernet port, a wireless transmitter, etc. In an embodiment of the present invention, the communication device 309 periodically accesses the server computer 311 to provide data, e.g., raw sensed data (e.g., temperature readings, pressure readings, gas level readings and/or flow readings) or reports characterizing monitoring operations, for storage in the database 312. As such, the communication device 309 may access real-time data received by the controller 152 and any historical data stored on the local memory 153 for transfer to the database 312. In an alternative embodiment, the communication device 309 maintains communications with the server computer 311 over the communications network 313 continually; therefore, the local memory 153 is unnecessary for storing sensed data. Instead, the communication device 309 continually transmits real-time sensed data to the server computer 311.

In addition to data retrieval services, the server computer 311 is also operable to perform analyses on information retrieved from the controller 152 and prepare reports characterizing these analyses in similar fashion to the functionality described for the controller 152 above. That is, the server computer 311 retrieves raw sensed data (e.g., flow readings) stored on the memory 153 and analyzes the retrieved information to render conclusions regarding operation of the beverage dispensing system 100. These conclusions are preferably placed into report format and stored on the database 312 for future access by users.

The controller 152 can also receive commands from the server computer 311 via the communications network 313 to provide a feedback loop to the control system 128. These commands may be used to control processes and operations of the beverage dispensing system 100. Such commands may include calibration commands, test commands, alarm commands, interactive communications between the system (100) operator or service technician and the server computer (311), and other remote control commands. This capability facilitates the management of multiple, geographically dispersed beverage dispense systems 100 by allowing an operator or the service technician to distribute control commands from a central location via the communications network 313.

A client computer 314, e.g., a thick or thin client, is connected to the server computer 311 by way of communication link 315 or, alternatively, the communications network 313, as shown in dashed lines. The client computer 314 communicates with the server computer 311 to retrieve data from the database 312 for presentation to a user. As such, the client computer 314 receives reports stored in the database 312 and provides these reports to a user. Alternatively, the client computer 314 may include an analysis application operable to receive raw sensed data stored in the database 312 and analyze this data to generate reports, as described above with reference to the controller 152 and the server computer 311.

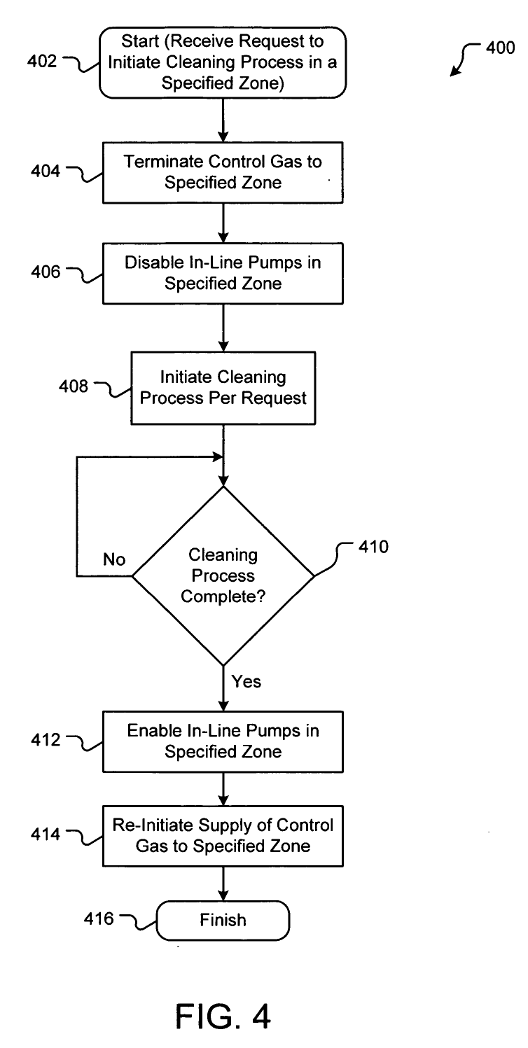

Referring now to FIG. 4, a process 400 for controlling operation of beverage pumps 180 incorporated into the beverage dispensing system 100 in order to facilitate performance of a cleaning process is shown in accordance with an embodiment of the present invention. The control process 400 embodies a sequence of computer-implemented operations performed by the controller 152, the server computer 311 and/or the client computer 314, or a combination of any of these three computing modules, in accordance with embodiments of the present invention. For illustrative purposes, therefore, the control process 400 is also described herein as performed by the controller 152.

The control process 400 is performed using an operation flow that begins with a start operation 402 and concludes with a terminate operation 416. The start operation 402 is initiated in response to receipt by the controller 152 of a request to initiate a cleaning process relative to any one zone in the beverage dispensing system 100. Such a request may embody instructions received through the GUI 158, the IR Port 129, the communication device 309 (e.g., by way of server computer 311 or client computer 314) or by way of key switches, as described in greater detail in incorporated U.S. patent application Ser. Nos. 10/985,302 and 11/142,995. After this request has been received, the operation flow passes from the start operation 402 to a terminate operation 404.

The terminate operation 404 terminates supply of the control gas to the specified zone thereby concluding the beverage dispensing process in preparation for starting the cleaning process in that zone. The operation flow of the control process 400 then passes passed to a disable operation 406 upon completion.

The disable operation 406 disables all beverage pumps 180 integrated into any of the beverage lines 108 categorized within the specified zone. In accordance with an embodiment of the present invention, the disable operation 404 involves the controller 152 issuing an instruction to any associated power sources 182 requesting de-activation of the corresponding pumps 180. Thus, for any electric pumps in the specified zone, de-activation occurs by an associated power source 182 switching off the supply of electric power to those pumps 180. Similarly, for any pneumatic pumps in the specified zone, de-activation occurs by an associated power source 182 terminating the supply of air or pressure to those pumps 180. After all of the beverage pumps 180 in the specified zone have been disabled, the operation flow of the control process 400 passes to a clean operation 408.

The clean operation 408 initiates application of the cleaning process to the specified zone per the received request and subsequently passes the operation flow to a query operation 410. The query operation 410 determines whether the cleaning process is complete and, if so, passes the operation flow to an enable operation 412. Otherwise, the query operation 410 passes the operation flow in a loop during which the query operation 410 is repetitively performed until the cleaning process is complete. After such completion, the enable operation 412 enables the beverage pumps 180 in the specified zone such that the pumps 180 are operable to perform intended functionality (i.e., facilitating communication of beverages within beverage lines 108). From the enable operation 412, the operation flow passes to a supply operation 414.

The supply operation 414 re-initiates supply of the control gas to each of the gas lines 148 coupled to the gas-fluid junction 132 corresponding to the specified zone, thereby preparing the beverage dispensing system 800 for the beverage dispensing process. After the control gas has been re-supplied to the specified zone, the operation flow passes to the terminate operation 416.

While FIGS. 1-4 are directed to embodiments of the present invention that involve administering a cleaning process using the integrated cleaning system described above, FIG. 5 illustrates an alternative approach to cleaning components of a beverage dispensing system 500. This alternative approach involves the application of an icy or slushy product through the beverage lines, e.g., 108, of the beverage dispensing system 500. In an embodiment, the icy or slushy product is generated by applying of ultrasonic waves to beverages or other fluids during communication of these beverages or fluids through the beverage lines, e.g., 108, to create an icy or slushy product therefrom. Accordingly, these ultrasonic waves transfer any such beverages and fluids into an abrasive product that, when communicated through the beverage lines, e.g., 108, remove any soil deposits or residue contained in the lines, e.g., 108, when output through opened dispense units, e.g., 102.

To accomplish this, an ultrasonic wave generator 501 is positioned in close proximity to a beverage line 108 of a beverage dispensing system 500, as shown in illustrative fashion in FIG. 5. The beverage dispensing system 500 is shown to include only a single beverage container 104, a single beverage line 108 and a single associated dispense unit 102, but as described above, may include any number of these components. As such, an embodiment of the invention involves the beverage dispensing system 500 having a like number of ultrasonic wave generators. Alternatively, a single ultrasonic wave generator 501 may serve multiple beverage lines 108, particularly if those beverage lines 108 are in close proximity to one another.

The ultrasonic wave generator 501 is powered by an electric power source 502, which, in an embodiment is a switch that, when enabled, provides the requisite electrical power to the ultrasonic wave generator 501. Initiating a cleaning process therefore involves activating the power source 502 to supply power to the ultrasonic wave generator 501, which in turn, generates ultrasonic waves that are propagated in the direction of to the beverage line 108. The temperature within the walk-in cooler 162 is maintained slightly above freezing (i.e., 33-36 degrees Fahrenheit). Consequently, the beverage contained in the beverage container 104 is maintained at substantially this slightly above freezing temperature such that, in response to the dispense unit 102 being positioned in the on position 102a thereby causing the beverage to be pressured out of the container 104 and through the beverage line 108, the ultrasonic waves transform the beverage into a icy or slushy product. As this icy or slushy product moves through the beverage line 108, any soil or residue in the line 108 is gathered (by abrasion) and transported out of the opened dispense unit 102. After a sufficient time for cleaning the beverage line 108, the power to the ultrasonic wave generator 501 is switched off at the power source 202 such that the beverage dispensing process may resume.

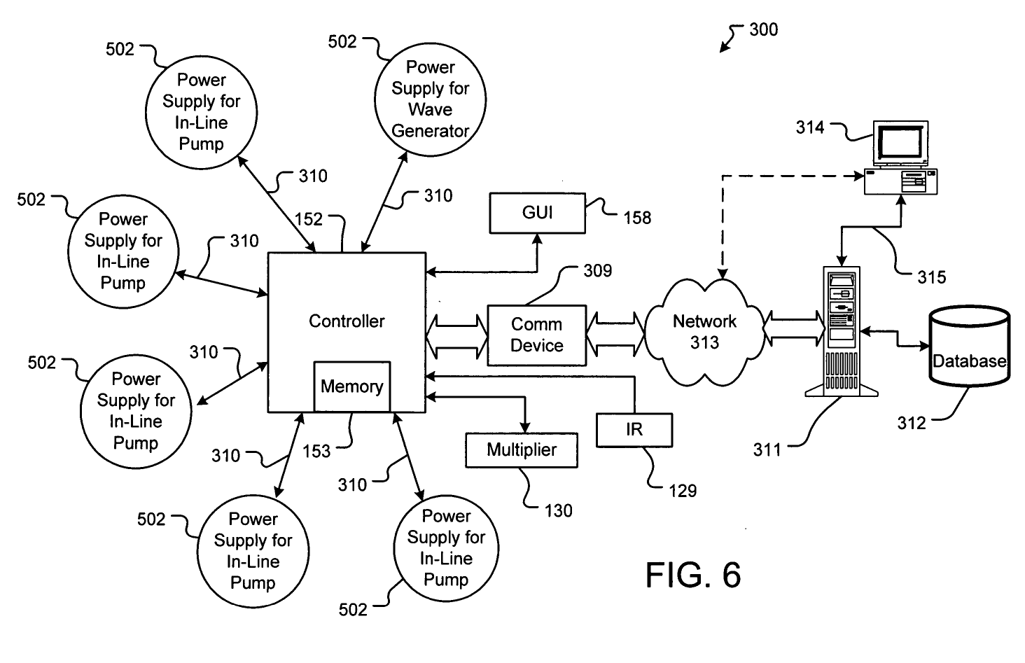

In an embodiment, the power source 502 is enabled and disabled manually by a user to activate and deactivate, respectively, the ultrasonic wave generator 501. Alternatively, the power source 502 may be controlled by a controller 152, as generally illustrated in FIG. 6. To accomplish this, the power sources 502 for the ultrasonic wave generator 501 are communicatively coupled to the controller 152 using data communication lines 310, as described in connection with FIG. 3. Such an implementation is particularly useful in a beverage dispensing system 500 being controlled from a remote location.

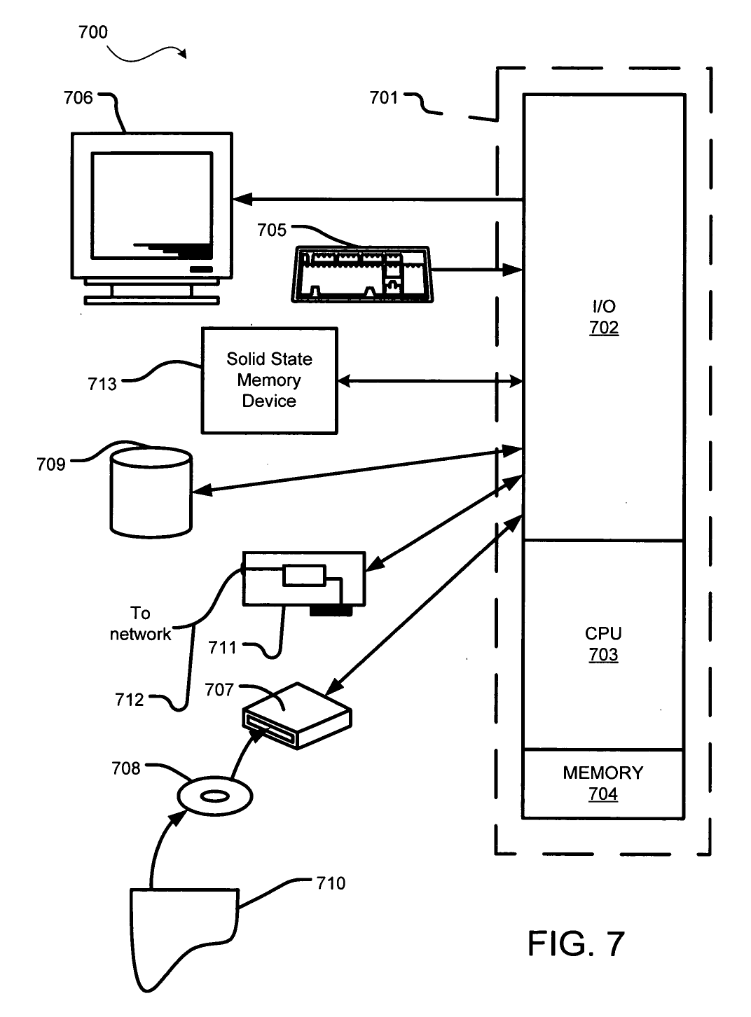

Having described the embodiments of the present invention with reference to the figures above, it should be appreciated that numerous modifications may be made to the present invention that will readily suggest themselves to those skilled in the art and which are encompassed in the spirit of the invention disclosed and as defined in the appended claims. Indeed, while a presently preferred embodiment has been described for purposes of this disclosure, various changes and modifications may be made which are well within the scope of the present invention. For example, the controller 152 is described herein as conventional electrical and electronic devices/components, such as, without limitation, programmable logic controllers (PLC's) and logic components, but may alternatively be a processor 701 integrated into a computer readable medium environment as optionally shown in FIG. 7. As such, the logical operations of the present invention described herein may be administered by the processor 701 in this computer readable medium environment.

Referring to FIG. 7, such an embodiment is shown by a computing system 700 capable of executing a computer readable medium embodiment of the present invention. In such a system, data and program files may be input to the computing system 700, which reads the files and executes the programs therein. Some of the elements of a computing system 700 are shown in FIG. 7 wherein the processor 701 includes an input/output (I/O) section 702, a microprocessor, or Central Processing Unit (CPU) 703, and a memory section 704. The present invention is optionally implemented in this embodiment in software or firmware modules loaded in memory 704 and/or stored on a solid state, non-volatile memory device 713, a configured CD-ROM 708 or a disk storage unit 709. As such, the computing system 700 is used as a “special-purpose” machine for implementing the present invention.

The I/O section 702 is connected to a user input module 705, e.g., a keyboard, a display unit 706, etc., and one or more program storage devices, such as, without limitation, the solid state, non-volatile memory device 713, the disk storage unit 709, and the disk drive unit 707. The solid state, non-volatile memory device 713 is an embedded memory device for storing instructions and commands in a form readable by the CPU 703. In accordance with various embodiments, the solid state, non-volatile memory device 713 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with this embodiment, the disk drive unit 707 may be a CD-ROM driver unit capable of reading the CD-ROM medium 708, which typically contains programs 710 and data. Alternatively, the disk drive unit 707 may be replaced or supplemented by a floppy drive unit, a tape drive unit, or other storage medium drive unit. Computer readable media containing mechanisms (e.g., instructions, modules) to effectuate the systems and methods in accordance with the present invention may reside in the memory section 704, the solid state, non-volatile memory device 713, the disk storage unit 709 or the CD-ROM medium 708. Further, the computer readable media may be embodied in electrical signals representing data bits causing a transformation or reduction of the electrical signal representation, and the maintenance of data bits at memory locations in the memory 704, the solid state, non-volatile memory device 713, the configured CD-ROM 708 or the storage unit 709 to thereby reconfigure or otherwise alter the operation of the computing system 700, as well as other processing signals. The memory locations where data bits are maintained are physical locations that have particular electrical, magnetic, or optical properties corresponding to the data bits.

In accordance with a computer readable medium embodiment of the present invention, software instructions stored on the solid state, non-volatile memory device 713, the disk storage unit 709, or the CD-ROM 708 are executed by the CPU 703. In this embodiment, these instructions may be directed toward administering application of a cleaning process, customized or non-customized, to a beverage dispensing system. Data used in the analysis of such applications may be stored in memory section 704, or on the solid state, non-volatile memory device 713, the disk storage unit 709, the disk drive unit 707 or other storage medium units coupled to the system 700.

In accordance with one embodiment, the computing system 700 further comprises an operating system and usually one or more application programs. Such an embodiment is familiar to those of ordinary skill in the art. The operating system comprises a set of programs that control operations of the computing system 700 and allocation of resources. The set of programs, inclusive of certain utility programs, also provide a graphical user interface to the user. An application program is software that runs on top of the operating system software and uses computer resources made available through the operating system to perform application specific tasks desired by the user. The operating system is operable to multitask, i.e., execute computing tasks in multiple threads, and thus may be any of the following: any of Microsoft Corporation's “WINDOWS” operating systems, IBM's OS/2 WARP, Apple's MACINTOSH OSX operating system, Linux, UNIX, etc.

In accordance with yet another embodiment, the processor 701 connects to the communications network 313 by way of a network interface, such as the network adapter 711 shown in FIG. 7. Through this network connection, the processor 701 is operable to transmit information to the remote computer 310, as described in connection with the controller 152 shown in FIG. 3. Various types of information may be transmitted from the processor 701 to the remote computer 310 over the network connection. In addition, the network adaptor 711 enables users at the remote computer 310 or the client computer 314 the ability to issue commands to the processor 701 if so desired, also as described above in connection with the controller 152.

In addition, while the icy or slushy product is described with reference to FIG. 5 as being formed using an ultrasonic wave generator 501, alternative means for transforming beverages and other fluids into an icy or slushy product are contemplated within the scope of the present invention. Additionally, while the beverage dispensing system 500 in accordance with this embodiment is shown in FIG. 5 as a stand-alone dispensing system 500 without an integrated cleaning system, it should be appreciated that the ultrasonic wave generator 501 may be used in conjunction with the beverage dispensing system 100 of FIG. 1. As such, the cleaning fluids and water used during the cleaning process may be stored at slightly above freezing temperature and subjected to the ultrasonic waves to create an icy or slushy product as described above. Also, in this embodiment, the ultrasonic wave generators 501 are preferably controlled by the controller 152.

In yet another embodiment, the control process 400 includes an additional operation (not shown) in which the beverage pumps 180 integrated into the beverage lines 108 categorized within the specified zone are activated for a relatively brief period time during the cleaning process to enable cleaning fluids to contact the internal parts of the pumps 180. This additional operation is preferably incorporated into the control process after the clean operation 408, but prior to the query operation 410.

Even further, the walk-in cooler 162 is described above as being maintained slightly above freezing (i.e., 33-36 degrees Fahrenheit) such that the beverage contained in the beverage container 104 is output to the beverage lines 108 at substantially this slightly above freezing temperature in accordance with an exemplary embodiment. It should be appreciated that an alternative embodiment involves maintaining the walk-in cooler 162 at this slightly above freezing temperature only for the time period during which slush cleaning is desired. In another alternative embodiment, the chemical dispense system 100 may include chillers (not shown), such as, for example, glycol coolers, situated on the beverage lines 108 prior to the ultrasonic wave generators 501. In this embodiment, the chillers cool the fluids (e.g., beverages) in the beverage lines 108 to the slightly above freezing temperature required to form the slushy, ice formation therein.

What is claimed is:

1. A computer-implemented method for cleaning a fluid dispensing system, wherein a fluid is supplied from a fluid container to a fluid line for communication to a dispense unit during fluid dispensing processes, the fluid line comprising a fluid pump facilitating the communication of fluid to the dispense unit, the method comprising:
receiving an instruction that requests cleaning of the fluid line;
in response to the instruction, disabling the fluid pump such that the fluid pump is not operable to facilitate the communication of fluid to the dispense unit; and
initiating the cleaning process by instructing supply of a substance to the fluid line for communication to the dispense unit.

2. A computer-implemented method as defined in claim 1, further comprising:
determining whether the cleaning process is complete; and
in response to determining that the cleaning process is complete, enabling operation of the fluid pump such that the fluid pump is operable to facilitate the communication of fluid to the dispense unit.

3. A computer-implemented method as defined in claim 1, wherein the fluid pump is an electric pump powered by an electric power source, the disabling act comprising:
transmitting a data signal to the electric power source to terminate the supply of power to the fluid pump.

4. A computer-implemented method as defined in claim 1, wherein the fluid pump is pneumatic pump powered by air from a pneumatic power source, the disabling act comprising:
transmitting a data signal to the pneumatic power source to terminate the supply of air to the fluid pump.

5. A computer-implemented method as defined in claim 1, wherein the substance provided to the fluid line during the cleaning process comprises water.

6. A computer-implemented method as defined in claim 5, wherein the substance further comprises an icy product.

7. A computer-implemented method as defined in claim 6, wherein the initiating act comprises:
instructing application of ultrasonic waves to the fluid line to create the icy product therein.

8. A computer-implemented method as defined in claim 1, wherein the substance provided to the fluid line during the cleaning process comprises the fluid in an icy form.

9. A computer-implemented method as defined in claim 8, wherein the initiating act comprises:
instructing application of ultrasonic waves to the fluid line to transform the fluid into the icy form.

10. A computer-implemented method as defined in claim 9, wherein the fluid is a beverage.

11. A fluid dispensing system comprising:
a fluid container storing a fluid;
a fluid line fluidly connected to the fluid container;
a dispense unit fluidly connected to the fluid line and comprising a valve, wherein fluid is operable to flow from the fluid container to the fluid line and out of the dispense unit when the valve is open;
a controller;
a fluid pump integrated into the fluid line and operable to facilitate communication of the fluid between the fluid container and the dispense unit when the valve is open; and
a power source operable to provide power to the fluid pump and communicatively coupled to the controller by way of a data communication link, wherein the controller is operable to selectively enable and disable the fluid pump by issuing control communications to the power source over the data communications link.

12. A fluid dispensing system as defined in claim 11, wherein the data communication link comprises a wire-based communication medium.

13. A fluid dispensing system as defined in claim 11, further comprising:
an ultrasonic wave generator positioned in relation to the fluid line and operable to propagate ultrasonic waves in the direction of the fluid line that transform the fluid flowing therein into an icy product.

14. A fluid dispensing system as defined in claim 13, wherein the ultrasonic wave generator is powered by a second power source, the second power source being communicatively coupled to the controller by way of a second data communication link, wherein the controller is operable to selectively enable and disable the ultrasonic wave generator by issuing control communications to the second power source over the second data communications link.

15. A fluid dispensing system as defined in claim 11, wherein the fluid pump is a pneumatic pump.

16. A fluid dispensing system as defined in claim 11, wherein the fluid pump is an electric pump.

17. A fluid dispensing system as defined in claim 11, wherein the fluid is a beverage and the fluid container is stored at a temperature slightly above freezing temperature.

18. A computer program product readable a computing system and encoding instructions for performing a method for cleaning a fluid dispensing system, wherein a fluid is supplied from a fluid container to a fluid line for communication to a dispense unit during fluid dispensing processes, the fluid line comprising a fluid pump facilitating the communication of fluid to the dispense unit, the method comprising:
receiving an instruction that requests cleaning of the fluid line;
in response to the instruction, disabling the fluid pump such that the fluid pump is not operable to facilitate the communication of fluid to the dispense unit;
initiating the cleaning process by instructing supply of a substance to the fluid line for communication to the dispense unit.

19. A computer program product as defined in claim 18, wherein the substance comprises water, the initiating act comprises:
instructing application of ultrasonic waves to the fluid line to create an icy product therein.

20. A computer-implemented method for cleaning a fluid dispensing system as defined in claim 18, wherein the substance provided to the fluid line during the cleaning process comprises the fluid in an icy form, the initiating act comprising:
instructing application of ultrasonic waves to the fluid line to transform the fluid to the icy form.
